(19) United States
(12) Patent Application Publication
(10) Pub. No.: US 2014/0123319 A1
(43) Pub. Date: May 1, 2014

(54) System, Method and Apparatus For Facilitating Resource Security

(71) Applicants: Niko Santeri Porjo, Piikkio (FI); Jakke Sakari Makela, Turku (FI); Petri J. Salonen, Oulu (FI)

(72) Inventors: Niko Santeri Porjo, Piikkio (FI); Jakke Sakari Makela, Turku (FI); Petri J. Salonen, Oulu (FI)

(73) Assignee: NOKIA CORPORATION, Espoo (FI)

(21) Appl. No.: 14/128,644

(22) PCT Filed: Jun. 27, 2011
(86) PCT No.: PCT/IB2011/052826

§ 371 Date: Dec. 23, 2013

(51) Int. Cl. G06F 21/62

(52) U.S. Cl. CPC G06F 21/6218
USPC 726/28

(57) ABSTRACT

A method and apparatus are provided for facilitating resource security. A method may include monitoring for resource requests by one or more applications on a device. The method may further include determining, based at least in part on the monitoring, that one of the one or more applications has requested access to a resource. The method may additionally include causing the determined resource request to be logged in a log of resource requests by the one or more applications. A corresponding apparatus is also provided.

### TECHNOLOGICAL FIELD

Example embodiments of the present invention relate generally to computer security and, more particularly, relate to a method and apparatus for facilitating resource security.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Many modern mobile computing devices are capable of running a wide variety of third party applications, also referred to as “apps,” which may be obtained from application stores and/or other application sources. These applications may access a wide variety of data and hardware resources on mobile computing devices, as well as external network resources, during operation. In some instances, use of resources by applications my risk exposure of potentially sensitive user data to third parties. While in some instances, such resource usage may be needed for operation of the application, some applications may access resources that are not needed for operation, thereby increasing the risk of exposure of sensitive user information.

### BRIEF SUMMARY

A system, method, and apparatus are herein provided for facilitating resource security. Systems, methods, and apparatuses in accordance with various embodiments may provide several advantages to computing devices, computing device users, applications, and application sources. For example, some example embodiments provide for monitoring and logging of resource requests made by applications on a device. As such, users may have access to data on resources being used by applications installed on their devices. In this regard, some example embodiments provide for monitoring resource requests by applications implemented on a device and provide information on the monitored requests. In some example embodiments, monitored resource requests may be leveraged to provide a user with advisories on applications that may be requesting more resources than needed for operation of the application, suggested security settings for restricting access to a resource by an application, and/or the like. Further, some example embodiments may enforce security settings, and deny a resource request if the requesting application has not been granted access to the requested resource. Accordingly, various example embodiments may facilitate resource security, thus enhancing privacy and information control and security.

In a first example embodiment, a method is provided, which may comprise monitoring for resource requests by one or more applications on a device. The method of this example embodiment may further comprise determining, based at least in part on the monitoring, that one of the one or more applications has requested access to a resource. The method of this example embodiment may additionally comprise causing the determined resource request to be logged in a log of resource requests by the one or more applications.

In another example embodiment, an apparatus comprising at least one processor and at least one memory storing computer program code is provided. The at least one memory and stored computer program code may be configured, with the at least one processor, to cause the apparatus of this example embodiment to at least monitor for resource requests by one or more applications on a device. The at least one memory and stored computer program code may be configured, with the at least one processor, to further cause the apparatus of this example embodiment to determine, based at least in part on the monitoring, that one of the one or more applications has requested access to a resource. The at least one memory and stored computer program code may be configured, with the at least one processor, to also cause the apparatus of this example embodiment to cause the determined resource request to be logged in a log of resource requests by the one or more applications.

In a further example embodiment, an apparatus is provided that may comprise means for monitoring for resource requests by one or more applications on a device. The apparatus of this example embodiment may further comprise means for determining, based at least in part on the monitoring, that one of the one or more applications has requested access to a resource. The apparatus of this example embodiment may additionally comprise means for causing the determined resource request to be logged in a log of resource requests by the one or more applications.

In yet another example embodiment, a method is provided, which may comprise receiving, from a device, data relating to logged resource requests by an application on the device. The method of this example embodiment may further comprise analyzing the received data to determine resource usage of the application. The method of this example embodiment may additionally comprise causing information about the determined resource usage of the application to be provided.

In still a further example embodiment, an apparatus comprising at least one processor and at least one memory storing computer program code is provided. The at least one memory and stored computer program code may be configured, with the at least one processor, to cause the apparatus of this example embodiment to at least receive, from a device, data relating to logged resource requests by an application on the device. The at least one memory and stored computer program code may be configured, with the at least one processor, to further cause the apparatus of this example embodiment to analyze the received data to determine resource usage of the application. The at least one memory and stored computer program code may be configured, with the at least one processor, to also cause the apparatus of this example embodiment to cause information about the determined resource usage of the application to be provided.

In another example embodiment, an apparatus is provided that may comprise means for receiving, from a device, data relating to logged resource requests by an application on the device. The apparatus of this example embodiment may further comprise means for analyzing the received data to determine resource usage of the application. The apparatus of this example embodiment may additionally comprise means for causing information about the determined resource usage of the application to be provided.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an example system in which applications may be implemented according to some example embodiments;

FIG. 2 illustrates an example system for facilitating resource security according to some example embodiments;

FIG. 3 is a schematic block diagram of a mobile terminal according to some example embodiments;

FIG. 4 illustrates a block diagram of an apparatus according to some example embodiments;

FIG. 5 illustrates a block diagram of an analysis apparatus according to some example embodiments;

FIG. 6 illustrates operation of an example system for facilitating resource security in accordance with some example embodiments;

FIG. 7 illustrates a flowchart according to an example method for facilitating resource security according to some example embodiments;

FIG. 8 illustrates a flowchart according to another example method for facilitating resource security according to some example embodiments; and

FIG. 9 illustrates a flowchart according to yet another example method for facilitating resource security according to some example embodiments.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

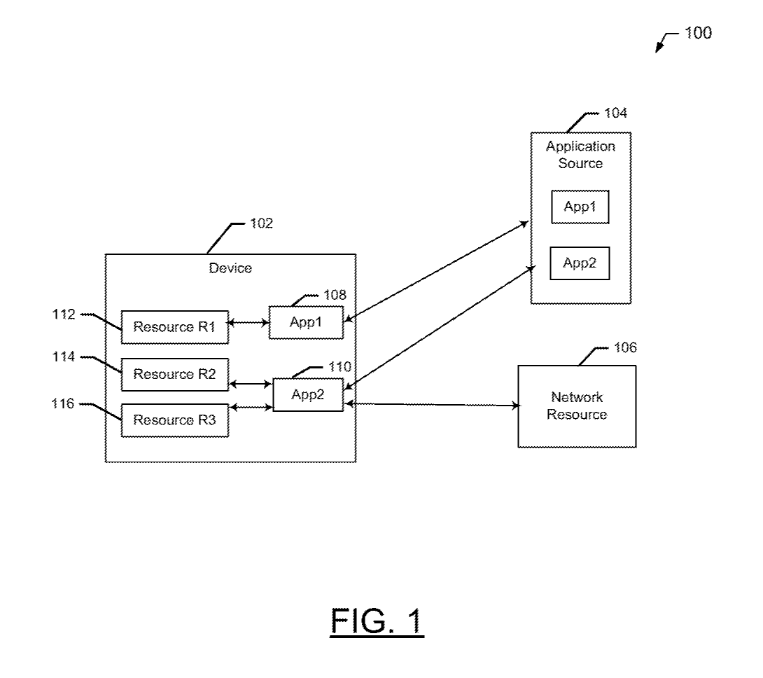

FIG. 1 illustrates an example system 100 in which applications may be implemented according to some example embodiments. In this regard, the system 100 may include a device 102. The device 102 may, for example, comprise a mobile computing device, such as a cellular phone, capable of running applications. However, it will be appreciated that the device 102 is not limited to being embodied as a mobile computing device, and may comprise any type of computing device capable of running applications.

The system 100 may further include an application source 104. The application source 104 may comprise a network entity from which applications can be obtained (for example, downloaded) by the device 102. The application source 104 may, for example, comprise an apparatus providing access to a structured application store, such as may be maintained by a manufacturer of the device 102, a manufacturer of an operating system that may be implemented on the device 102, a network operator operating a network that may be used by the device 102, or the like. As an example, the application source 104 may provide access to applications available from Nokia's OVI™ service. The application source 104 may accordingly, by way of non-limiting example, be embodied as one or more servers, a server cluster, a cloud computing infrastructure, one or more desktop computers, one or more laptop computers, one or more network nodes, multiple computing devices in communication with each other, any combination thereof, and/or the like.

The system 100 may additionally include one or more network resources 106. A network resource may comprise any resource that may be accessed by an application on the device 102 over a network, such as via an Internet Protocol (IP) address, uniform resource locator (URL), or other uniform resource identifier (URI). In this regard, a network resource 106 may comprise a web page, data accessible over a network, a server or other apparatus accessible over a network, a service available over a network, or the like. In this regard, it will be appreciated that the application source 104 may be considered a network resource.

The device 102 may be able to communicate and exchange data with the application source 104 and/or network resource 106 via a network. Such network may comprise one or more wireless networks (for example, a cellular network, wireless local area network, wireless personal area network, wireless metropolitan area network, and/or the like), one or more wireline networks, or some combination thereof, and in some embodiments may comprise at least a portion of the internet.

There may be one or more applications installed on the device 102. Two such applications, the App1 108 and App2 110, are illustrated by way of example in FIG. 1. The device 102 may additionally include one or more internal resources. Such internal resources may, for example, comprise locally stored data. Such locally stored data may, for example, include personal information of a user of the device 102. As another example, such internal resources may comprise hardware resources, such as, a global positioning system (GPS) receiver, sensor, network adapter, and/or the like. Three such internal resources, the Resource R1 112, Resource R2 114, and Resource R3 116, are illustrated by way of example in FIG. 1.

During the course of operation, the applications installed on the device 102 may access internal resources of the device 102 and/or network resources. In this regard, when an application is installed, it may be given access to some internal resources of the device 102. Further, the application may be granted the ability to contact network resources. For example, an application may transfer data between the device 102 and the application source 104, or other network resource. By way of example, FIG. 1 illustrates the App1 108 as accessing the internal resource R1 112 and the application source 104. The App2 110 is illustrated as accessing the internal resources R2 114 and R3 116. The App2 110 is further illustrated as exchanging data with the application source 104 and network resource 106.

Some example embodiments provide for monitoring of such resource requests by applications installed on devices, such as the device 102. Some such example embodiments may facilitate resource security by informing a user of resource requests made by applications running on his or her device.

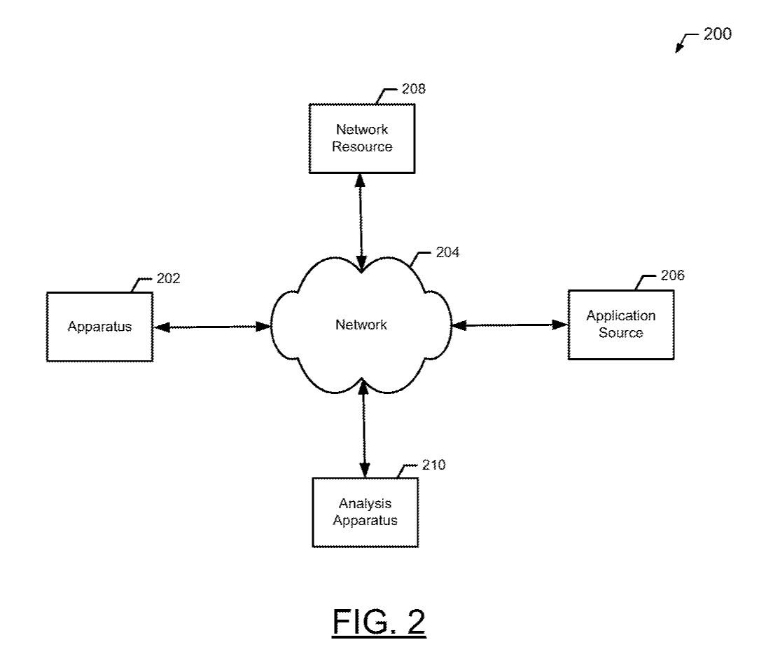

FIG. 2 illustrates an example system 200 for facilitating resource security according to some example embodiments. The system may include one or more apparatuses 202. An apparatus 202 may comprise any computing device on which applications may be installed and run, which is configured to monitor resource requests by such applications in accordance with one or more example embodiments. By way of non-limiting example, the apparatus 202 may comprise a desktop computer, laptop computer, mobile terminal, mobile computer, mobile phone, mobile communication device, tablet computing device, game device, digital camera/camcorder, audio/video player, television device, radio receiver, digital video recorder, positioning device, wrist watch, portable digital assistant (PDA), a chipset, an apparatus comprising a chipset, any combination thereof, and/or the like.

The system 200 may further comprise one or more application sources 206, which may be embodied similarly to the application source 104 described in connection with FIG. 1. An apparatus 202 may obtain (for example, download) applications from an application source 206 via a network, such as the network 204. The network 204 may comprise one or more wireless networks (for example, a cellular network, wireless local area network, wireless personal area network, wireless metropolitan area network, and/or the like), one or more wireline networks, or some combination thereof, and in some embodiments may comprise at least a portion of the internet.

The system 200 may additionally comprise one or more network resources 208. A network resource 208 may be embodied similarly to the network resource 106 described in connection with the system 100. Accordingly, a network resource 208 may comprise any resource that may be accessed by an application on the apparatus 202 over the network 204, such as via an Internet Protocol (IP) address, uniform resource locator (URL), or other uniform resource identifier (URI). By way of non-limiting example, a network resource 208 may comprise a web page, data that may be accessible over the network 204, a server or other apparatus that may be accessible over the network 204, a service that may be available over the network 204, or the like. In this regard, it will be appreciated that an application source 206 may be considered a network resource.

In some example embodiments, the system 200 may further include an analysis apparatus 210. In this regard, an analysis apparatus 210 may be present in embodiments wherein data related to logged resource requests monitored on an apparatus 202 may be transferred to a trusted party for analysis as will be described further herein below. As such, the analysis apparatus 210 may comprise an entity maintained by a trusted party, such as a party trusted by a user of the apparatus 202, manufacturer of the apparatus 202, operator of the network 204, and/or the like. As one example, the analysis apparatus 210 may be maintained by the Electronic Frontier Foundation (EFF). As another example, the analysis apparatus 210 may be maintained by an entity responsible for operating an application store. As such, in some example embodiments, the analysis apparatus 210 may be co-located with an application source 206. By way of non-limiting example, the analysis apparatus 210 may be may be embodied as one or more servers, a server cluster, a cloud computing infrastructure, one or more desktop computers, one or more laptop computers, one or more mobile computers, one or more network nodes, multiple computing devices in communication with each other, a chipset, an apparatus comprising a chipset, any combination thereof, and/or the like.

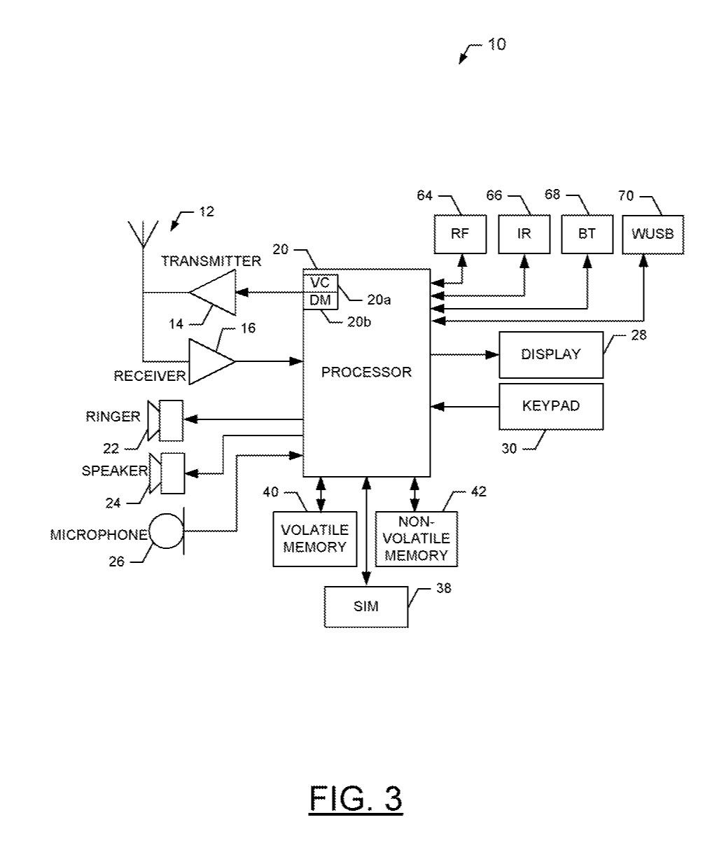

FIG. 3 illustrates a block diagram of a mobile terminal 10 representative of some example embodiments of an apparatus 102. It should be understood, however, that the mobile terminal 10 illustrated and hereinafter described is merely illustrative of one type of apparatus 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). The mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric (0-9) and related keys (#, *), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like. The mobile terminal 10 may comprise memory, such as a removable or non-removable subscriber identity module (SIM) 38, a soft SIM 38, a fixed SIM 38, a removable or non-removable universal subscriber identity module (USIM) 38, a soft USIM 38, a fixed USIM 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40, non-volatile memory 42 may also include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

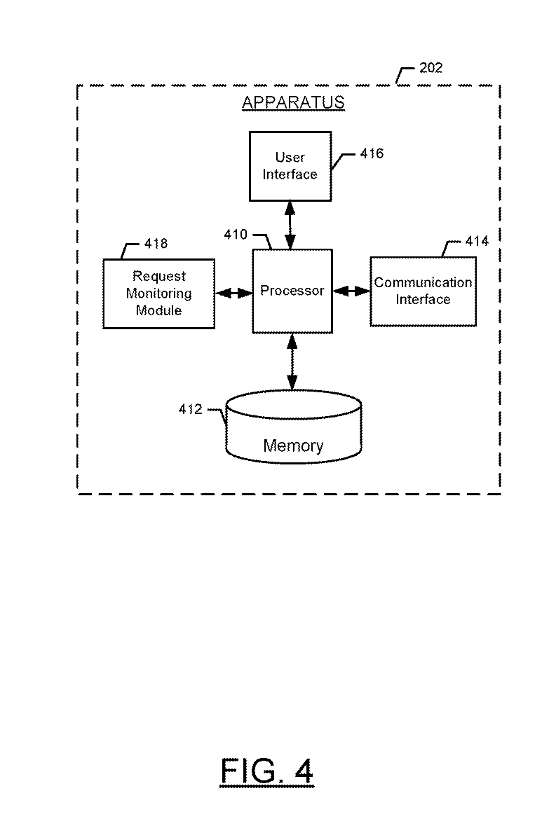

Referring now to FIG. 4, FIG. 4 illustrates a block diagram of an apparatus 202 in accordance with some example embodiments. In some example embodiments, the apparatus 202 may include various means for performing the various functions herein described. These means may comprise one or more of a processor 410, memory 412, communication interface 414, user interface 416, or request monitoring module 418. The means of the apparatus 202 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 412) that is executable by a suitably configured processing device (for example, the processor 410), or some combination thereof.

In some example embodiments, one or more of the means illustrated in FIG. 4 may be embodied as a chip or chip set. In other words, the apparatus 202 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 410, memory 412, communication interface 414, user interface 416, and/or request monitoring module 418 may be embodied as a chip or chip set. The apparatus 202 may therefore, in some example embodiments, be configured to implement example embodiments of the present invention on a single chip or as a single “system on a chip.” As another example, in some example embodiments, the apparatus 202 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 410 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 4 as a single processor, in some example embodiments the processor 410 may comprise a plurality of processors. The plurality of processors may be in operative communication with each other and may be collectively configured to perform one or more functionalities of the apparatus 202 as described herein. The plurality of processors may be embodied on a single computing device or distributed across a plurality of computing devices collectively configured to function as the apparatus 202. In embodiments wherein the apparatus 202 is embodied as a mobile terminal 10, the processor 410 may be embodied as or may comprise the processor 20. In some example embodiments, the processor 410 is configured to execute instructions stored in the memory 412 or otherwise accessible to the processor 410. These instructions, when executed by the processor 410, may cause the apparatus 202 to perform one or more of the functionalities of the apparatus 202 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an ASIC, FPGA or the like, the processor 410 may comprise specifically configured hardware for conducting one or more operations described herein. Alternatively, as another example, when the processor 410 is embodied as an executor of instructions, such as may be stored in the memory 412, the instructions may specifically configure the processor 410 to perform one or more algorithms and operations described herein.

The memory 412 may comprise, for example, volatile memory, non-volatile memory, or some combination thereof. In this regard, the memory 412 may comprise one or more non-transitory computer-readable storage mediums. Although illustrated in FIG. 4 as a single memory, the memory 412 may comprise a plurality of memories. The plurality of memories may be embodied on a single computing device or may be distributed across a plurality of computing devices collectively configured to function as the apparatus 202. In various example embodiments, the memory 412 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 202 is embodied as a mobile terminal 10, the memory 412 may comprise the volatile memory 40 and/or the non-volatile memory 42. The memory 412 may be configured to store information, data, applications, instructions, or the like for enabling the apparatus 202 to carry out various functions in accordance with various example embodiments. For example, in some example embodiments, the memory 412 may be configured to buffer input data for processing by the processor 410. Additionally or alternatively, the memory 412 may be configured to store program instructions for execution by the processor 410. The memory 412 may store information in the form of static and/or dynamic information. The stored information may, for example, include a log of resource requests by one or more applications installed on the apparatus 202. This stored information may be stored and/or used by the request monitoring module 418 during the course of performing its functionalities.

The communication interface 414 may be embodied as any device or means embodied in circuitry, hardware, a computer program product comprising computer readable program instructions stored on a computer readable medium (for example, the memory 412) and executed by a processing device (for example, the processor 410), or a combination thereof that is configured to receive and/or transmit data from/to another computing device. According to some example embodiments, the communication interface 414 may be at least partially embodied as or otherwise controlled by the processor 410. In this regard, the communication interface 414 may be in communication with the processor 410, such as via a bus. The communication interface 414 may include, for example, an antenna, a transmitter, a receiver, a transceiver and/or supporting hardware or software for enabling communications with one or more remote computing devices. The communication interface 414 may be configured to receive and/or transmit data using any protocol that may be used for communications between computing devices. In this regard, the communication interface 414 may be configured to receive and/or transmit data using any protocol that may be used for transmission of data between the apparatus 202 and one or more computing devices (for example, another apparatus 202, an application source 206, network resource 208, analysis apparatus 210, and/or the like) with which the apparatus 202 may be in communication over the network 204. The communication interface 414 may additionally be in communication with the memory 412, user interface 416, and/or request monitoring module 418, such as via a bus(es).

The user interface 416 may be in communication with the processor 410 to receive an indication of a user input and/or to provide an audible, visual, mechanical, or other output to a user. As such, the user interface 416 may include, for example, a keyboard, a mouse, a joystick, a display, a touch screen display, a microphone, a speaker, and/or other input/output mechanisms. In embodiments wherein the user interface 416 comprises a touch screen display, the user interface 416 may additionally be configured to detect and/or receive an indication of a touch gesture or other input to the touch screen display. The user interface 416 may be in communication with the memory 412, communication interface 414, and/or request monitoring module 418, such as via a bus(es).

The request monitoring module 418 may be embodied as various means, such as circuitry, hardware, a computer program product comprising computer readable program instructions stored on a computer readable medium (for example, the memory 412) and executed by a processing device (for example, the processor 410), or some combination thereof and, in some example embodiments, may be embodied as or otherwise controlled by the processor 410. In embodiments wherein the request monitoring module 418 is embodied separately from the processor 410, the request monitoring module 418 may be in communication with the processor 410. The request monitoring module 418 may further be in communication with one or more of the memory 412, communication interface 414, or user interface 416, such as via a bus(es).

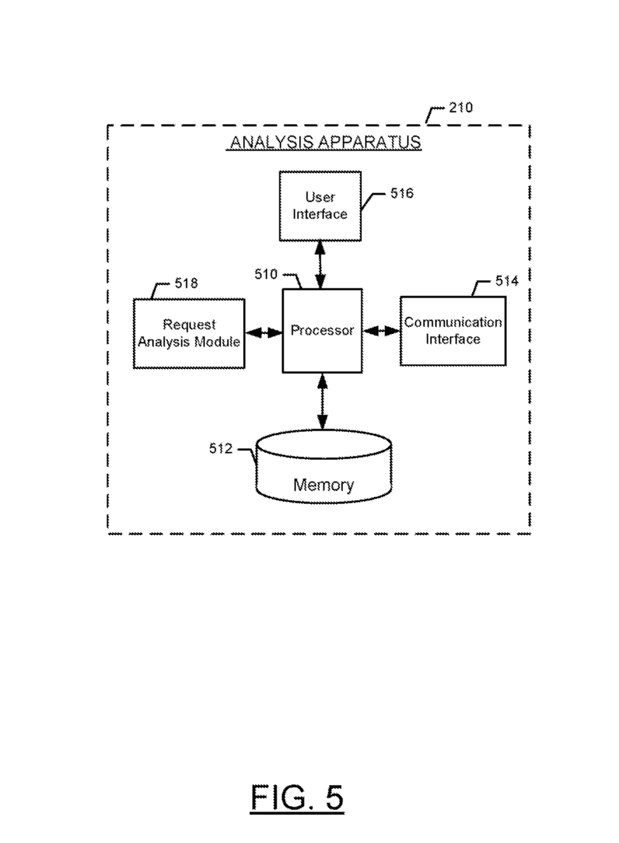

Referring now to FIG. 5, FIG. 5 illustrates a block diagram of an analysis apparatus 210 in accordance with some example embodiments. In some example embodiments, the analysis apparatus 210 may include various means for performing the various functions herein described. These means may comprise one or more of a processor 510, memory 512, communication interface 514, user interface 516, or request analysis module 518. The means of the analysis apparatus 210 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 512) that is executable by a suitably configured processing device (for example, the processor 510), or some combination thereof.

In some example embodiments, one or more of the means illustrated in FIG. 5 may be embodied as a chip or chip set. In other words, the analysis apparatus 210 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 510, memory 512, communication interface 514, user interface 516, and/or request analysis module 518 may be embodied as a chip or chip set. The analysis apparatus 210 may therefore, in some example embodiments, be configured to implement example embodiments of the present invention on a single chip or as a single “system on a chip.” As another example, in some example embodiments, the analysis apparatus 210 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 510 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 5 as a single processor, in some example embodiments the processor 510 may comprise a plurality of processors. The plurality of processors may be in operative communication with each other and may be collectively configured to perform one or more functionalities of the analysis apparatus 210 as described herein. The plurality of processors may be embodied on a single computing device or distributed across a plurality of computing devices collectively configured to function as the analysis apparatus 210. In some example embodiments, the processor 510 is configured to execute instructions stored in the memory 512 or otherwise accessible to the processor 510. These instructions, when executed by the processor 510, may cause the analysis apparatus 210 to perform one or more of the functionalities of the analysis apparatus 210 as described herein. As such, whether configured by hardware or software methods, or by a combination thereof, the processor 510 may comprise an entity capable of performing operations according to embodiments of the present invention while configured accordingly. Thus, for example, when the processor 510 is embodied as an ASIC, FPGA or the like, the processor 510 may comprise specifically configured hardware for conducting one or more operations described herein. Alternatively, as another example, when the processor 510 is embodied as an executor of instructions, such as may be stored in the memory 512, the instructions may specifically configure the processor 510 to perform one or more algorithms and operations described herein.

The memory 512 may comprise, for example, volatile memory, non-volatile memory, or some combination thereof. In this regard, the memory 512 may comprise one or more non-transitory computer-readable storage mediums. Although illustrated in FIG. 5 as a single memory, the memory 512 may comprise a plurality of memories. The plurality of memories may be embodied on a single computing device or may be distributed across a plurality of computing devices collectively configured to function as the analysis apparatus 210. In various example embodiments, the memory 512 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 512 may be configured to store information, data, applications, instructions, or the like for enabling the analysis apparatus 210 to carry out various functions in accordance with various example embodiments. For example, in some example embodiments, the memory 512 may be configured to buffer input data for processing by the processor 510. Additionally or alternatively, the memory 512 may be configured to store program instructions for execution by the processor 510. The memory 512 may store information in the form of static and/or dynamic information. The stored information may, for example, include a log of resource requests by one or more applications installed on the apparatus 202 (or multiple apparatuses 202) and sent to the analysis apparatus 210. This stored information may be stored and/or used by the request analysis module 518 during the course of performing its functionalities.

The communication interface 514 may be embodied as any device or means embodied in circuitry, hardware, a computer program product comprising computer readable program instructions stored on a computer readable medium (for example, the memory 512) and executed by a processing device (for example, the processor 510), or a combination thereof that is configured to receive and/or transmit data from/to another computing device. According to some example embodiments, the communication interface 514 may be at least partially embodied as or otherwise controlled by the processor 510. In this regard, the communication interface 514 may be in communication with the processor 510, such as via a bus. The communication interface 514 may include, for example, an antenna, a transmitter, a receiver, a transceiver and/or supporting hardware or software for enabling communications with one or more remote computing devices. The communication interface 514 may be configured to receive and/or transmit data using any protocol that may be used for communications between computing devices. In this regard, the communication interface 514 may be configured to receive and/or transmit data using any protocol that may be used for transmission of data between the analysis apparatus 210 and one or more computing devices (for example, an apparatus 202) with which the analysis apparatus 210 may be in communication over the network 204. The communication interface 514 may additionally be in communication with the memory 512, user interface 516, and/or request analysis module 518, such as via a bus(es).

The user interface 516 may be in communication with the processor 510 to receive an indication of a user input and/or to provide an audible, visual, mechanical, or other output to a user. As such, the user interface 516 may include, for example, a keyboard, a mouse, a joystick, a display, a touch screen display, a microphone, a speaker, and/or other input/output mechanisms. In embodiments wherein the user interface 516 comprises a touch screen display, the user interface 516 may additionally be configured to detect and/or receive an indication of a touch gesture or other input to the touch screen display. In some example embodiments, aspects of the user interface 516 may be more limited, or the user interface 516 may even be removed. The user interface 516 may be in communication with the memory 512, communication interface 514, and/or request analysis module 518, such as via a bus(es).

The request analysis module 518 may be embodied as various means, such as circuitry, hardware, a computer program product comprising computer readable program instructions stored on a computer readable medium (for example, the memory 512) and executed by a processing device (for example, the processor 510), or some combination thereof and, in some example embodiments, may be embodied as or otherwise controlled by the processor 510. In embodiments wherein the request analysis module 518 is embodied separately from the processor 510, the request analysis module 518 may be in communication with the processor 510. The request analysis module 518 may further be in communication with one or more of the memory 512, communication interface 514, or user interface 516, such as via a bus(es).

In some example embodiments, the request monitoring module 418 may be configured to monitor for resource requests by one or more applications that may be installed on the apparatus 202. In some such embodiments, the request monitoring module 418 may be configured to actively monitor for and/or intercept resource requests made by an application. Additionally or alternatively, an application may be considered to route resource requests through the request monitoring module 418. Accordingly, the request monitoring module 418 may be configured to passively monitor resource requests by noting resource requests received at or passing through the request monitoring module 418.

The request monitoring module 418 may accordingly be configured to determine, based at least in part on the monitoring, that an application has requested access to a resource. In an instance in which an application has requested access to a resource, the request monitoring module 418 may be configured to cause the resource request to be logged in a log of resource requests by the one or more monitored applications. Such a log may be maintained by the request monitoring module 418 in the memory 412. While the structure of the log is not limited to any particular data structure, in some example embodiments, the log may comprise a database.

In some example embodiments, the request monitoring module 418 may be configured to log only a subset of resources that may be accessed by an application. In this regard, the request monitoring module 418 may be configured with a list of resources to monitor for requests and/or to log. For example, a user of the apparatus 202, device manufacturer, network operator, or other entity may select which resources are logged and/or otherwise define parameters governing how detailed the logging is. The request monitoring module 418 may accordingly be configured to selectively log resource requests in accordance with such logging configuration settings.

In logging a resource request, the request monitoring module 418 may be configured to log the resource request in association with the application making the request. For example, each monitored application may be associated with an identifier, and the request monitoring module 418 may be configured to log a resource request in association with the identifier for the application making the resource request. Accordingly, in embodiments wherein the log comprises a database, the identifier for an application may serve as a database key for any resource requests and associated information that may be logged with respect to that application.

The identifier for a respective application, may, for example, be assigned by the request monitoring module 418 or other element of the apparatus 102, and thus may be unique only among the applications installed on the apparatus 202. Alternatively, however, the identifier may be a globally unique identifier among application installs in a system, such as the system 200. In this regard, a globally unique identifier may not only distinguish one application from another (for example, distinguish a navigation application from a game application), but may distinguish a particular installation of an application on the apparatus 202 from installations of the same application on other devices. Accordingly, for example, if a social networking application is installed on 100 different devices on which resource requests by the social networking application may be monitored, each installation of the social networking application may be assigned a unique identification code. Such a globally unique identifier may, for example, be assigned by an application store or other software provider or source, such as at the time an application is downloaded to the apparatus 202. A globally unique identifier may comprise a randomly assigned string or code that is long enough to ensure that the identifier is unlikely to be assigned to another application installation.

It will be appreciated that the request monitoring module 418 may log additional information attendant to a resource request beyond the resource requested and the application making the request. For example, a time of the request, operating conditions of the apparatus 202 when the request was made, and/or other information may be logged as well. In some example embodiments, however, the request monitoring module 418 may not log any information about data actually accessed or exchanged by the application when using a resource. In this regard, for example, in some example embodiments what information flows out of the apparatus 202 may be transparent to the request monitoring module 418, although the request monitoring module 418 may know the resource (for example, a network resource 208) with which information was exchanged.

The request monitoring module 418 may be further configured to cause information relating to logged resource requests to be provided to a user, such as via the user interface 416. For example, a user of the apparatus 202 may be provided with a graphical user interface by which the user may selectively view and interact with data about logged resource requests. Information provided to a user may include raw logged request data. Additionally or alternatively, a user may selectively view or filter data by resource, by application, or the like. Accordingly, the user may evaluate whether his or her private information may be being misused by an application by noting resources used by the application.

Information provided to the user based on logged resource requests may be derived locally at the apparatus 202, such as by the request monitoring module 418. Additionally or alternatively, the information may be at least partially derived by an analysis apparatus 210. In this regard, in some example embodiments, the request monitoring module 418 may be configured to cause data from the log of resource requests to be provided to the analysis apparatus 210. The logged data shared with the analysis apparatus 210 may contain only information on which resources have been requested, and not information about data that has been used by an application so as to avoid exposing private user data to a third party maintaining the analysis apparatus 210. In such embodiments, the request analysis module 518 may receive the data and may analyze the data to determine information about resource usage by an application installed on the apparatus 202. The request analysis module 518 may cause the determined information to be provided to the apparatus 202, such that the request monitoring module 418 may provide the information to a user of the apparatus 202.

In embodiments wherein logged data is shared with the analysis apparatus 210, a user of the apparatus 202 may subscribe to a service that may be provided via the analysis apparatus 210 by a trusted third party, such as a trusted application store, the EFF, or the like, which may provide analysis of resource usage by an application and inform users of potentially nefarious activity by an application, possible malware applications, suggested security settings, and/or the like.

The analysis apparatus 210 may be configured to receive logged resource request data from a plurality of apparatuses 202. In such embodiments, the request analysis module 518 may be configured to aggregate this data. Accordingly, for example, resource requests by a given application that may be installed on several devices may be aggregated and analyzed to determine whether the application poses a security risk to sensitive user data. In such embodiments, the request analysis module 518 may maintain a database of received resource request data. The database may be organized by the identifier associated with received resource request data. Accordingly, for example, in embodiments wherein a particular application install is assigned a globally unique identifier, the identifier may serve as a key into the database for resource requests by the particular installation of the application on the given device. Thus, the request analysis module 518 may be configured to sort and analyze collected data on a global level across multiple installations for a given application, as well as at an individual device level for a selected installation of the application.

In some example embodiments, a user may be informed if an application is requesting an unapproved resource. For example, a user may be informed if an application is requesting a resource that is not in a list of approved resources of the application. The list of approved resources may, for example, comprise a list of one or more resources known to be used for functioning of the application. As another example, a trusted party, such as the EFF may analyze an application and, based on the analysis, determine a list of one or more resources that are approved for use by the application, such as those that may be needed for functioning of the application. Similarly, a user may be informed if an application is requesting a resource that is in a list of unapproved resources for the application.

The request monitoring module 418 and/or request analysis module 518 may accordingly analyze resource requests by an application and compare the requested resources to of the list of approved resources and/or a list of unapproved for the application. If the application has requested a resource that is not approved, the application may be determined to have requested a resource an unapproved resource. The user may be further informed of a degree of potential risk of the application accessing the unapproved resource. For example, if the requested resource risks exposing sensitive user data, the risk may be classified higher than if, for example, the application requested access to a benign resource, such as a backlight functionality that may be included on embodiments wherein the apparatus 202 comprises a mobile terminal. In some example embodiments, if the risk of an application accessing an unapproved resource is below a threshold risk level, the user may not even be notified of the resource request.

Information provided to the user based on logged data may further comprise a recommended security setting restricting access to a resource by an application. In this regard, the request monitoring module 418 and/or request analysis module 518 may suggest a security setting based on a type of application, known resource needs of the application, logged previous resource requests by the application, and/or the like. The user may optionally confirm or decline implementation of the recommended security setting. Alternatively, in some example embodiments, certain recommended security settings may be implemented automatically without user approval, such as if the user has authorized automatic configuration of security settings. For example, in embodiments wherein the analysis apparatus 210 is appropriately authorized, the request analysis module 518 may be configured to cause configuration of a security setting implemented at the apparatus 202 to restrict an application from accessing a resource.

In some example embodiments, the request monitoring module 418 may be configured to implement security settings restricting resource access. In this regard, the request monitoring module 418 may implement a “gate” between an application and a resource, which may receive a resource request from an application and selectively authorize or deny the request based on whether the application is restricted from accessing the request. Accordingly, if the application is authorized to access the resource, the request monitoring module 418 may allow the request to pass through the “gate” to the requested resource. However, if the application is restricted from accessing the resource, the request may be denied and the request may be blocked by the “gate.”

Further, in some example embodiments, access to resources may be selectively restricted based on an operating mode of the apparatus 202. For example, in embodiments wherein the apparatus 202 may be implemented on a mobile phone, if the user has selected a “silent” profile, access to image and audio resources may be limited by the request monitoring module 418. For example while operating in a “silent” profile mode, only call applications that came from the manufacturer of the phone may be allowed access to those image and audio resources, while third party phone applications may be denied access to image and audio resources.

As another example, access to network resources may be restricted in the event of various conditions. For example, in some example embodiments, conditions such as battery power being below a threshold power level, connection to a network in which data charges are applied, low bandwidth, and/or the like may trigger the request monitoring module 418 to restrict access by some applications to certain network resources. Accordingly, for example, if an application that is usable even without an outside connection to a network resource(s), the application may be restricted from accessing network resources.

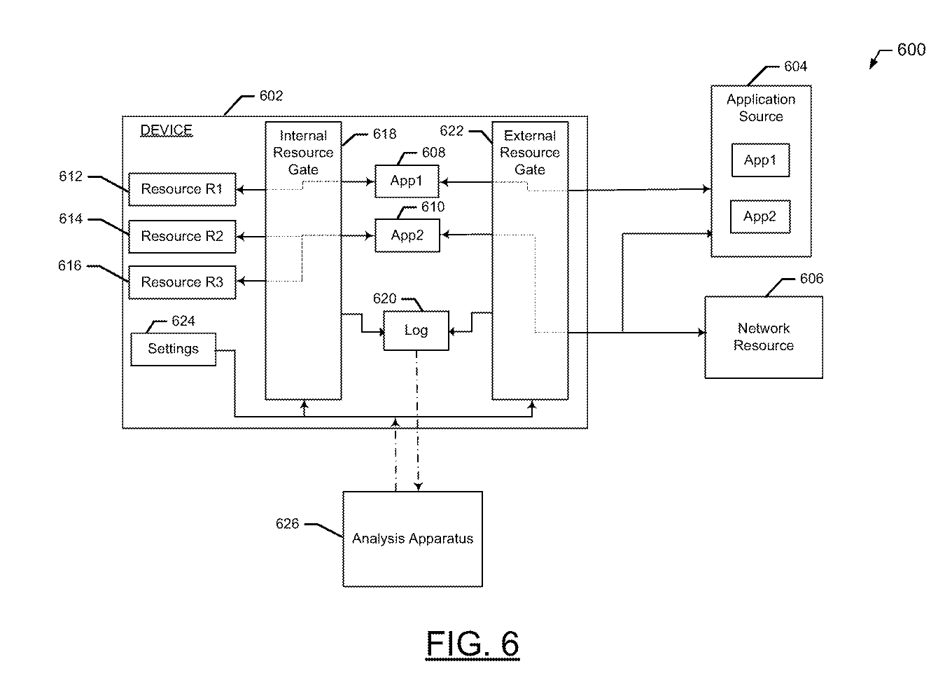

FIG. 6 illustrates operation of an example system for facilitating resource security in accordance with some example embodiments. In this regard, FIG. 6 illustrates an example implementation of some example embodiments on the system described with respect to FIG. 1. In this regard, the system 600 may comprise a device 602, on which an embodiment of the apparatus 202 may be implemented. The device 602 may be configured to communicate with an application source 604 and/or network resource 606 via a network, such as the network 204. By way of example, the device 602 is illustrated as having two example applications, App1 608 and App2 610, installed. These applications may, for example, have been obtained from the application source 604, as illustrated in FIG. 6. The device 602 may further include a plurality of internal resources, such as the Resource R1 612, Resource R2 614, and Resource R3 616.

The request monitoring module 418 of the embodiment illustrated in FIG. 4 may implement a resource gate(s), which may receive and/or intercept resource requests made by the App1 608 and App2 610. By way of example, two such resource gates are illustrated in FIG. 6. The internal resource gate 618 may serve as a gate for requests for internal resources, such as the Resource R1 612, Resource R2 614, and Resource R3 616. The external resource gate 622 may serve as a gate for requests to external network resources, such as the application source 604 and network resource 606. While the internal resource gate 618 and external resource gate 622 are illustrated in FIG. 6 as separate entities to illustrate the conceptual operation, it will be appreciated that some example embodiments may implement a single resource gate, which may handle both internal resource requests and external resource requests.

The request monitoring module 418 of the embodiment illustrated in FIG. 4 may be further configured to maintain the log 620 of monitored resource requests. In this regard, resource requests received by the internal resource gate 618 and/or by the external resource gate 622 may be logged in the log 620.

In the example of FIG. 6, the App1 608 is illustrated as requesting access to the internal resource R1 612 and the application source 604. The App2 610 is illustrated as requesting access to the internal resources R2 614 and R3 616. The App2 610 is further illustrated as requesting to exchange data with the application source 604 and network resource 606. These requests are illustrated as dotted lines through the internal resource gate 618 and external resource gate 622 to illustrate that the respective gates may grant/deny the resource requests in accordance with the security settings 624. In this regard, if an application is restricted from accessing a requested resource, the request may be blocked by the gate 618 or gate 622. If, however, the application is not restricted from accessing a requested resource, the request may be forwarded to the appropriate resource.

In some example embodiments, the system 600 may further comprise an analysis apparatus 626, which may comprise an embodiment of the analysis apparatus 210. In such embodiments, data from the log 620 may be provided to the analysis apparatus 626 for analysis. The request analysis module 518 associated with the analysis apparatus 626 may analyze the received data to determine information about resource usage of the App1 608 and/or App2 610 and may provide that information to the device 602. The provided information may include an indication of whether one of the applications is accessing a resource that is not needed for functioning, recommended security settings restricting resource access by one of the applications, and/or the like. In some example embodiments, the analysis apparatus 626 may have permission to automatically configure security settings based on the analysis of the log data. Accordingly, in such embodiments, the analysis apparatus 626 may configure one of the security settings 624 to grant/restrict access to a resource by an application.

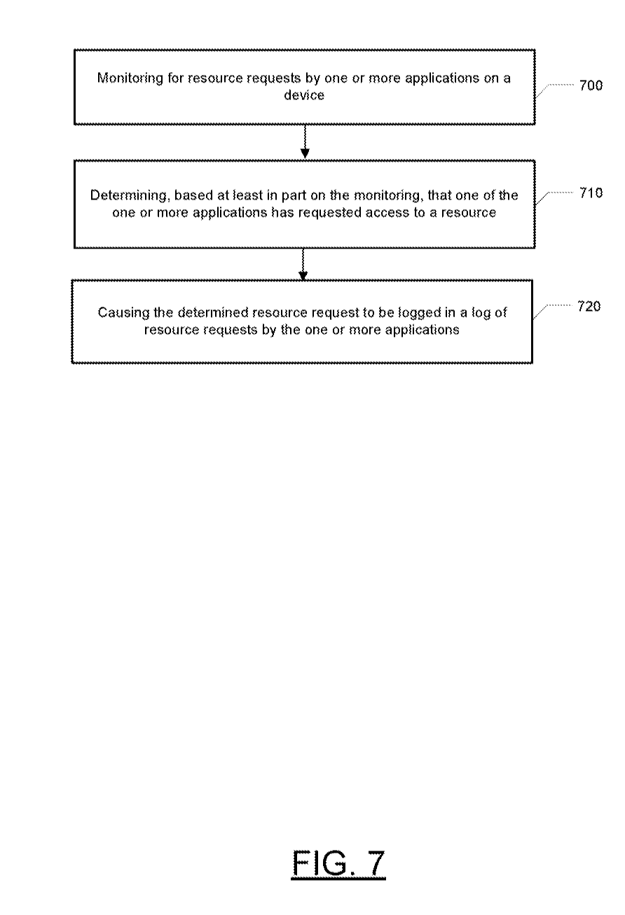

FIG. 7 illustrates a flowchart according to an example method for facilitating resource security according to some example embodiments. In this regard, FIG. 7 illustrates operations that may be performed at the apparatus 202. The operations illustrated in and described with respect to FIG. 7 may, for example, be performed by, with the assistance of, and/or under the control of one or more of the processor 410, memory 412, communication interface 414, user interface 416, or request monitoring module 418. Operation 700 may comprise monitoring for resource requests by one or more applications on a device. The processor 410, memory 412, and/or request monitoring module 418 may, for example, provide means for performing operation 700. Operation 710 may comprise determining, based at least in part on the monitoring, that one of the one or more applications has requested access to a resource. The processor 410, memory 412, and/or request monitoring module 418 may, for example, provide means for performing operation 710. Operation 720 may comprise causing the determined resource request to be logged in a log of resource requests by the one or more applications. The processor 410, memory 412, and/or request monitoring module 418 may, for example, provide means for performing operation 720.

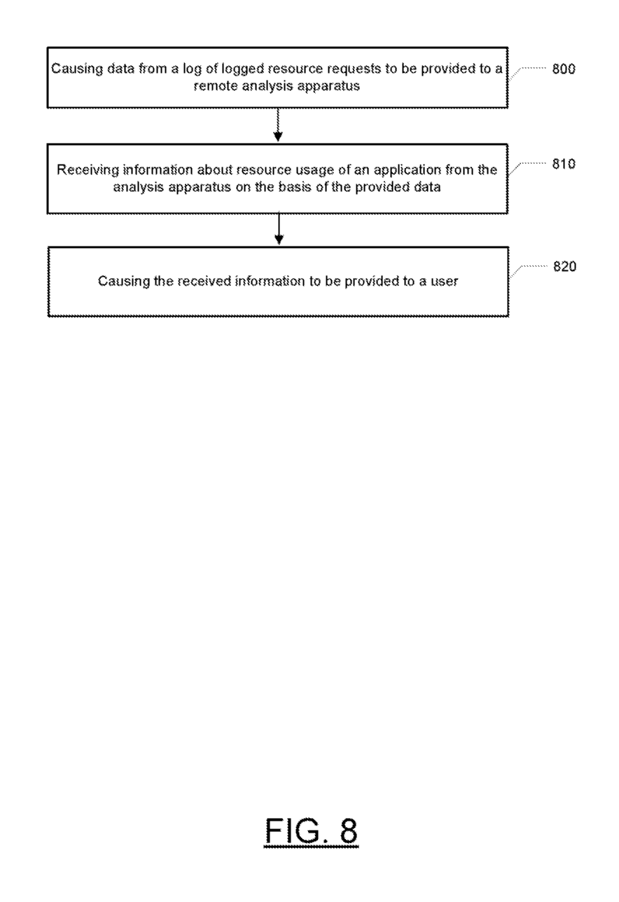

FIG. 8 illustrates a flowchart according to another example method for facilitating resource security according to some example embodiments. In this regard, FIG. 8 illustrates operations that may be performed at the apparatus 202. The operations illustrated in and described with respect to FIG. 8 may, for example, be performed by, with the assistance of, and/or under the control of one or more of the processor 410, memory 412, communication interface 414, user interface 416, or request monitoring module 418. Operation 800 may comprise causing data from a log of logged resource requests to be provided to a remote analysis apparatus. The provided data may, for example, include data logged in operation 720 of FIG. 7. The processor 410, memory 412, communication interface 414, and/or request monitoring module 418 may, for example, provide means for performing operation 800. Operation 810 may comprise receiving information about resource usage of an application from the analysis apparatus on the basis of the provided data. The processor 410, memory 412, communication interface 414, and/or request monitoring module 418 may, for example, provide means for performing operation 810. Operation 820 may comprise causing the received information to be provided to a user. The processor 410, memory 412, user interface 416, and/or request monitoring module 418 may, for example, provide means for performing operation 820.

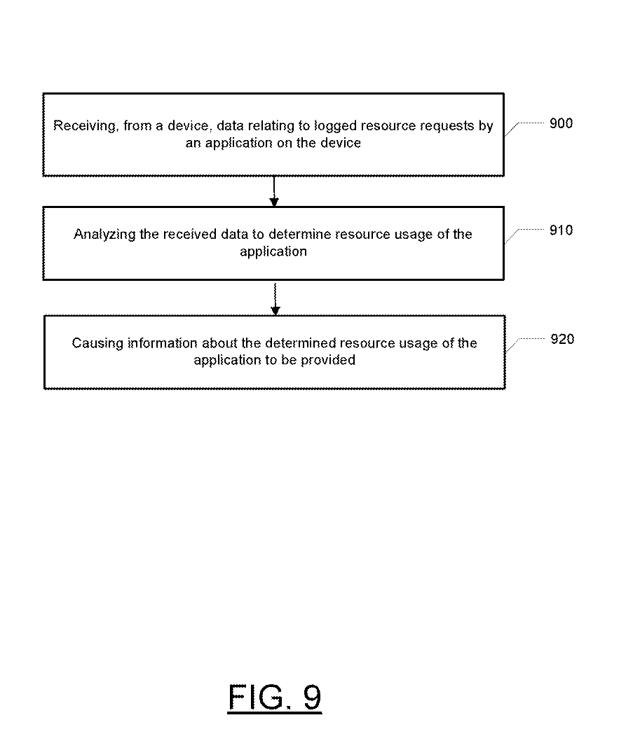

FIG. 9 illustrates a flowchart according to yet another example method for facilitating resource security according to some example embodiments. In this regard, FIG. 9 illustrates operations that may be performed at the analysis apparatus 210. The operations illustrated in and described with respect to FIG. 9 may, for example, be performed by, with the assistance of, and/or under the control of one or more of the processor 510, memory 512, communication interface 514, user interface 516, or request analysis module 518. Operation 900 may comprise receiving, from a device, data relating to logged resource requests by an application on the device. The processor 510, memory 512, communication interface 514, and/or request analysis module 518 may, for example, provide means for performing operation 900. Operation 910 may comprise analyzing the received data to determine resource usage of the application. The processor 510, memory 512, and/or request analysis module 518 may, for example, provide means for performing operation 910. Operation 920 may comprise causing information about the determined resource usage of the application to be provided. The processor 510, memory 512, communication interface 514, and/or request analysis module 518 may, for example, provide means for performing operation 920.

FIGS. 7-9 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 412 and/or memory 512) and executed by a processor in the computing device (for example, by the processor 410 and/or processor 510). In some example embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 202, analysis apparatus 210, and/or the like) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, an apparatus 202, analysis apparatus 210, and/or the like) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. According to some example embodiments, a suitably configured processor (for example, the processor 410 and/or processor 510) may provide all or a portion of the elements. In other example embodiments, all or a portion of the elements may be configured by and operate under control of a computer program product. The computer program product for performing the methods of some example embodiments may include a computer-readable storage medium (for example, the memory 412 and/or memory 512), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
monitoring for resource requests by one or more applications on a device;
determining, based at least in part on the monitoring, that one of the one or more applications has requested access to a resource;
causing the determined resource request to be logged in a log of resource requests by the one or more applications;
causing data from the log to be provided to a remote analysis apparatus; and
causing information relating to one or more logged resource requests to be provided to a user, wherein the provided information is received from a remote analysis apparatus, the analysis apparatus having derived the provided information based at least in part on data from the log reported by the device to the analysis apparatus.

2. The method of claim 1, wherein each of the one or more applications is associated with an identifier, and wherein causing the determined resource request to be logged comprises causing the determined resource request to be logged in association with the identifier associated with the application making the resource request.

3. The method of claim 2, wherein the identifier associated with the application making the resource request comprises a globally unique identifier that distinguishes the install of the application on the device from installs of the same application on other devices as well as from other applications.

4. (canceled)

5. The method of claim 1, wherein in an instance in which an application has been determined to request an unapproved resource, causing information to be provided comprises causing an indication of the unapproved resource request and the application making the unapproved resource request to be provided.

6. The method of claim 1, wherein causing information to be provided comprises causing a recommended security setting restricting access to a resource by an application to be provided.

7.-8. (canceled)

9. The method of claim 1, further comprising:
determining whether the application requesting access to the resource has been restricted from accessing the resource; and
denying the resource request in an instance in which it is determined that the application requesting access to the resource has been restricted from accessing the resource.

10.-11. (canceled)

12. An apparatus comprising at least one processor and at least one memory storing computer program code, wherein the at least one memory and stored computer program code are configured, with the at least one processor, to cause the apparatus to at least:
monitor for resource requests by one or more applications on a device;
determine, based at least in part on the monitoring, that one of the one or more applications has requested access to a resource;
cause the determined resource request to be logged in a log of resource requests by the one or more applications;
causing data from the log to be provided to a remote analysis apparatus; and
causing information relating to one or more logged resource requests to be provided to a user, wherein the provided information is received from a remote analysis apparatus, the analysis apparatus having derived the provided information based at least in part on data from the log reported by the device to the analysis apparatus.

13. The apparatus of claim 12, wherein each of the one or more applications is associated with an identifier, and wherein the at least one memory and stored computer program code are configured, with the at least one processor, to cause the apparatus to cause the determined resource request to be logged at least in part by causing the determined resource request to be logged in association with the identifier associated with the application making the resource request.

14. The apparatus of claim 13, wherein the identifier associated with the application making the resource request comprises a globally unique identifier that distinguishes the install of the application on the device from installs of the same application on other devices as well as from other applications.

15. (canceled)

16. The apparatus of claim 12, wherein in an instance in which an application has been determined to request an unapproved resource, the at least one memory and stored computer program code are configured, with the at least one processor, to cause the apparatus to cause information to be provided at least in part by causing an indication of the unapproved resource request and the application making the unapproved resource request to be provided.

17. The apparatus of claim 12, wherein the at least one memory and stored computer program code are configured, with the at least one processor, to cause the apparatus to cause information to be provided at least in part by causing a recommended security setting restricting access to a resource by an application to be provided.

18.-19. (canceled)

20. The apparatus of claim 12, wherein the at least one memory and stored computer program code are configured, with the at least one processor, to further cause the apparatus to:
determine whether the application requesting access to the resource has been restricted from accessing the resource; and
deny the resource request in an instance in which it is determined that the application requesting access to the resource has been restricted from accessing the resource.

21. The apparatus of claim 12, wherein the apparatus comprises or is embodied on the device, the device comprising a mobile computing device, wherein the mobile computing device comprises user interface circuitry and user interface software stored on one or more of the at least one memory, and wherein the user interface circuitry and user interface software are configured to:
facilitate user control of at least some functions of the mobile computing device through use of a display; and
cause at least a portion of a user interface of the mobile computing device to be displayed on the display to facilitate user control of at least some functions of the mobile computing device.

22. (canceled)

23. A method comprising:
receiving, from a plurality of devices, data relating to logged resource requests by an application executing on one or more of the plurality of devices;
analyzing the received data to determine resource usage of the application; and
causing information about the determined resource usage of the application to be provided.

24. The method of claim 23, further comprising:
determining, based at least in part on analyzing the received data, that the application has requested an unapproved resource; and
wherein causing information to be provided comprises causing an indication of the unapproved resource request to be provided.

25. The method of claim 23, wherein causing information about the determined resource usage of the application to be provided comprises causing a recommended security setting restricting access to a resource by the application to be provided.

26. The method of claim 23, further comprising causing the application to be restricted from accessing a resource.

27. The method of claim 23, wherein receiving the data comprises receiving the data at an entity remote from the one or more of the plurality of devices.

28. The method of claim 23, wherein receiving the data comprises receiving the data at a source from which one or more of the plurality of devices obtained the application.

29.-30. (canceled)

31. An apparatus comprising at least one processor and at least one memory storing computer program code, wherein the at least one memory and stored computer program code are configured, with the at least one processor, to cause the apparatus to at least:
receive, from a plurality of devices, data relating to logged resource requests by an application executing on one or more of the plurality of devices;
analyze the received data to determine resource usage of the application; and
cause information about the determined resource usage of the application to be provided.

32.-36. (canceled)
